(19) United States
(12) Patent Application Publication
(10) Pub. No.: US 2006/0111830 A1
(43) Pub. Date: May 25, 2006

(54) Engine output control apparatus

(76) Inventors: Toshihiko Higashi, Tokyo (JP); Masayuki Kayano, Tokyo (JP); Shogo Matsuura, Tokyo (JP)

Correspondence Address: Jacobson Holman PLLC, 400 Seventh Street, N.W., Washington, DC, 20004, US

(21) Appl. No.: 11/286,422

(22) Filed: Nov. 25, 2005

(30) Foreign Application Priority Data
Nov. 25, 2004 (JP) 2004-340899

(51) Int. Cl. B60T 8/32

(52) U.S. Cl. 701/95; 701/93; 180/170

(57) ABSTRACT

An apparatus comprises a cruise control section to control an engine output according to an acceleration/deceleration demand set according to an acceleration/deceleration demand from a driver or a cruise control demand set to match an actual vehicle speed to a preset vehicle speed or to match a vehicle distance relative to a forward-going vehicle to a preset value, whichever demand is greater, a speed shift control section to shift gears and to control the engine output, and a switch control section to switch the cruise control section and speed shift control section according to their priority order. The speed shift control section, upon being switched by the switching control section to the cruise control section after the completion of the shift changing, returns the engine output back to that previous switching state based on the cruise control section.

### CROSS-REFERENCE TO RELATED APPLICATIONS

This application is based upon and claims the benefit of priority from prior Japanese Patent Application No. 2004-340899, filed Nov. 25, 2004, the entire contents of which are incorporated herein by reference.

### BACKGROUND OF THE INVENTION

1. Field of the Invention

The present invention relates to an engine output control apparatus and, in particular, an apparatus for controlling a fuel injection amount under cooperation control.

2. Description of the Related Art

In general, an engine output control apparatus controls a fuel injection amount based on an acceleration pedal opening angle corresponding to a driver's demand output—hereinafter referred to normal control.

Further, with a cruise SW ON, the target value of the engine output is set not according to the acceleration pedal opening angle but according to a cruise-set vehicle speed or an actual vehicle distance relative to a forward-going vehicle and the fuel injection amount is so controlled as to allow the actual engine output to approach this target value—hereinafter referred to cruise control.

Even in the actual control involved, a speed restriction device is sometimes operated such that, in order never to allow the actual vehicle speed to reach a predetermined value under the associated Laws and Regulations involved, the fuel injection amount is controlled to restrict the engine output - hereinafter referred to as speed restriction control.

On the other hand, the shift change becomes necessary due to various causes involved. In the shift change, the engine output control is temporarily shifted to speed shift control even if under the normal control, the cruise control or speed restriction control. In this speed control, the target value of the engine output is set based on both the actual vehicle speed and speed shift stage (gear ratio) and the fuel injection amount is so controlled as to match the actual engine output to the target value. After the shift change has been completed, that is, after the gear connection has been done, the engine output target value is set based on the acceleration pedal opening angle before control is returned back to the original control (normal control/cruise control/speed restriction control). And the fuel injection amount is so controlled as to set the actual engine output to be nearer to the target value-hereinafter referred to returning control. The returning control is so done as to prevent any abrupt change in engine output resulting from the switching of such control.

In the case of a shifting being made from the cruise control to the speed shift control, any driver in the cruise control usually releases the acceleration pedal, that is, sets his or her foot away from the acceleration pedal, and, under the returning control, the acceleration pedal stays released (sets his or her foot away from the acceleration pedal). In this case, under the returning control, the target value of the engine output is set based on the acceleration pedal. opening angle and, therefore, the target value of the engine output is set to zero, so that the vehicle “stalls”.

Where a shifting is done from the speed restriction control to the speed shift control, the driver in the speed restriction control depresses the acceleration pedal to a greater than necessary extent (allows the vehicle to run at a speed faster than the actual vehicle speed) and, even in the returning control, the acceleration pedal usually stays depressed to a greater than necessary extent. Since, in this case, the target value of the engine output is set based on the acceleration pedal opening angle in the returning control, the target value of the engine output will be set to a value which is higher than a predetermined vehicle speed, that is, a speed set under the speed restriction control. This involves a problem that the vehicle is quickly accelerated.

### BRIEF SUMMARY OF THE INVENTION

The object of the present invention is to provide an apparatus for controlling an engine output under cooperation control which can prevent a stall or abrupt acceleration in a shift change.

In one aspect of the present invention, there is provided an engine output control apparatus comprising a cruise control section configured to control an engine output according to an acceleration/deceleration demand set according to an acceleration/deceleration demand from a driver or a cruise control demand set to match an actual vehicle speed to a preset vehicle speed or to match a vehicle distance relative to a forward-going vehicle to a preset value, whichever demand is greater; a speed shift control section configured to shift gears and to control the engine output according to the actual vehicle speed; and a switching control section configure to switch the cruise control section and speed shift control section according to a priority order, wherein the speed shift control section, upon being switched by the switching control section to the cruise control section after the completion of the shift, controls the engine output based on the next control section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, 10 illustrate embodiments of the invention, and together with the general description given above and the detailed description of the embodiments given below, serve to explain the principles of the invention.

FIG. 1 is a view showing a system configuration of a fuel injection amount control device under the cooperation control in one embodiment of the present invention;

FIG. 2 is a flowchart for explaining the operation of switching control means in the embodiment;

FIG. 3A shows a fuel injection amount of an engine when a shifting is made from speed shift control to cruise control in the present embodiment and prior art case;

FIG. 3B is a view showing a fuel injection amount of an engine when a shifting is made from speed shift control to cruise control in the present embodiment and prior art case;

FIG. 4A is a view showing a fuel injection amount of an engine when a shifting is made from the speed shift control to speed restriction control in the present embodiment and prior art case; and

FIG. 4B is a view showing a fuel injection amount of an engine when a shifting is made from the speed shift control to the speed restriction control in the present embodiment and prior art case.

### DETAILED DESCRIPTION OF THE INVENTION

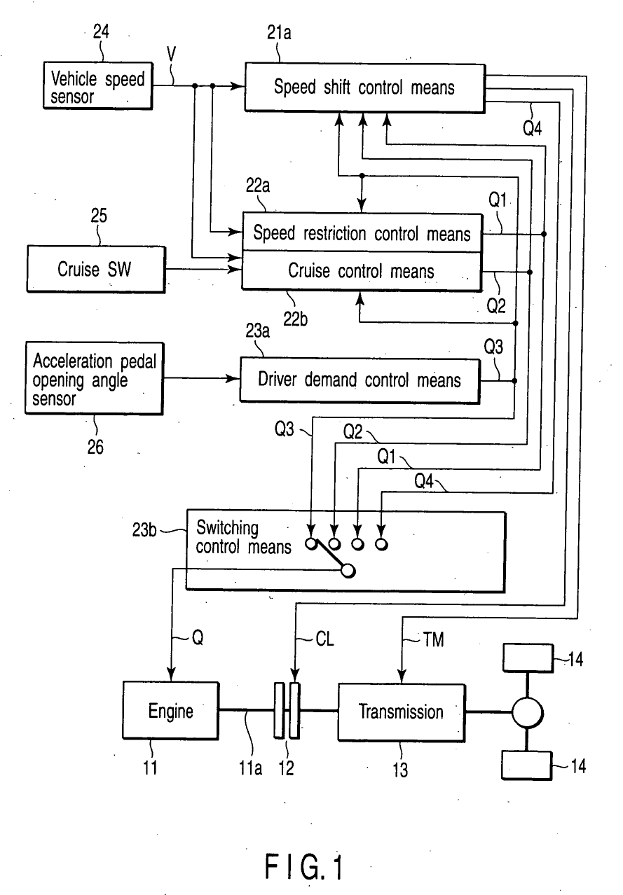

With reference to the drawing, an explanation will be made below about one embodiment of the present invention. FIG. 1 is a block diagram showing an apparatus for controlling a fuel injection amount under cooperation control. In the Figure, reference numeral 1 shows an engine and the rotation of an output shaft lla of the engine 11 is transmitted to drive shafts through a clutch 12 and transmission 13.

The control of the output of the engine 11 is done by controlling a fuel injection amount Q which is supplied to the engine 11. The fuel injection amount Q is calculated by respective means mounted on later-described speed shift control ECU (Electronic Control Unit) 21, MVCU (Multi Vehicle Control Unit) 22 and engine ECU 23.

Reference numeral 24 shows a vehicle speed sensor for detecting the vehicle speed. The vehicle speed V which is detected by the vehicle speed sensor 24 is input to vehicle speed control means 21a, speed restriction control means 22 and cruise control means 22b.

To the speed shift control means 21a are input a fuel injection amount Q1 calculated by the speed restriction control means 22a, a fuel injection amount Q2 calculated by the cruise control means 22b and a fuel injection amount Q3 calculated by a driver demand control means 23a.

Further, the speed control means 21a controls a fuel injection amount of the engine 11 at a speed shift time, a connection/disconnection of the clutch 12 and the shifting gears of the transmission 13. After the completion of the shifting gears, the fuel injection amount of the engine 11 is return-controlled so as to allow the smooth shifting of any other control. At the time of the shifting gears and after the completion of the shifting gears, the speed shift control means 21a calculates a fuel injection amount Q4 of the engine 11 until a shifting is done to any other control. Although in the present embodiment the above-mentioned functions of the speed shifting control means 21a are built in the speed shifting control ECU 21 and engine ECU 23, the present invention is not restricted thereto and they may be built in any other hardware.

Here, an explanation will be made below about returning control at the speed shift control means 21a. The speed shift control means 21a is higher in the priority order than any other control means (speed restriction control means 22a, cruise control means 22b and driver demand control means 23a). Where, even under any control being done by any other control means, it is necessary to effect the shifting gears (shift down or shift up) of the transmission (for example, there occurs a shortage of a deceleration torque on a steep uphill or any adequate acceleration is not obtained at a present gear situation), a priority is given to the control by the speed shift control means 21a. Even where however, control is shifted to the speed change control means 21a, if the shifting gears (shift-down, shift-up) is completed, the speed shifting control is quickly ended to allow a shifting to any other control means. At this time, the shifting to any specific control means is properly selected according to the state of the vehicle. That is, there are cases where a shifting may be made to the same control means as that control means immediately prior to switching to the speed change control means 21a or be made to different control means.

It is to be noted that the speed shifting control means 21a allows a shifting to any other control means not immediately after the completion of the shifting gears by the transmission 13 but after the returning control is effected. The main object of the returning control is to prevent any abrupt change in the output value of the engine which might occur due to extremely uncontinuous values taken by a fuel injection amount instruction resulting from the switching of the control methods.

In the returning control, from a switching control means 23b a notice is given to the speed shift control means 21a, indicating that the next control means is any specific control means. Then the speed shift control means 21a decides a fuel injection amount Q4 while following any specific fuel injection amount (any one of Q1, Q2 and Q3) based on the notified next control means to obtain a matching.

If there is a greater difference between the fuel injection amount Q4 upon the starting of the returning control after the completion of the shifting gears on one hand and any fuel injection amount (any one of Q1, Q2, Q3) based on the next speed shifting means on the other, the “following” speed may be changed. If, on the other hand, there is a smaller difference involved, the fuel injection amount Q4 may immediately be matched to the fuel injection amount (Q1, Q2, Q3) based on the next control means and further, even at a time of “not being fully matched”, returning control may be completed at a stage of “being matched to some extent”. By doing so, even if a shifting is made to the next control means, there occurs a situation under which no abrupt change in an engine output occurs. At this stage, the speed shift control means 21a ends the returning control and a shifting is made to the next control means.

The speed shifting control means 21a effects such returning control as set out above and smooth shifting is effected to the next control means. Since, in particular, the control is shifted without depending upon the acceleration pedal opening angle, even if the driver sets his or her foot away from the acceleration pedal in the case of effecting a shifting to an auto cruise control, there is an advantage that there occurs no unwanted stall. Further, even if a shifting is made to the speed restriction control (the driver depresses the acceleration pedal to any excessive extent), there is an advantage of preventing any unwanted acceleration.

The speed restriction control means 22a finds an actual vehicle speed based on a signal which is input from the vehicle speed sensor 24 and calculates the fuel injection amount of the engine 11 so as not to exceed any vehicle speeds which are set under the associated Laws and Regulations and Safty Restrictions, etc. In this connection it is to be noted that the speed restriction control means 22a follows the driver's acceleration demand if such a demand set based on the acceleration pedal opening angle falls within the regulated vehicle speed. Stated in more detail, the speed restriction control means 22a calculates the fuel injection amount Q1 by selecting a minimal value between the fuel injection amount Q3 of the engine 11 output from the later-described driver demand control means 23a and a maximal fuel injection amount falling within the regulated vehicle speed. Although in the present embodiment the speed restriction control means 22a is mounted on the MVCU 22 and engine ECU 23, the present invention is not restricted to the present structure and it may be mounted on any other hardware.

The cruise control means 22b finds the actual vehicle speed based the signal input from the vehicle speed sensor 24 and calculates the fuel injection amount of the engine in such a way as to allow the actual vehicle speed to be matched to the set vehicle speed previously set by the cruise SW 25. And the cruise control means 22b calculates the fuel injection amount Q2 by selecting a maximal value between the fuel injection amount Q3 output from the later-described driver demand control means 23a and such a fuel injection amount as to allow the actual vehicle speed to be matched to the set vehicle speed.

Although in the present embodiment the cruise control means 22b is mounted on the MVCM 22 and engine ECU 23, the present embodiment is not restricted thereto and it may be mounted on any other hardware.

The driver demand control means 23a finds the opening angle of the acceleration pedal, not shown, based on a signal input from the acceleration pedal opening angle sensor 26. And the driver demand control means 23a calculates the fuel injection amount Q3 of the engine 11 based on the acceleration pedal opening angle.

Although in the present embodiment the driver demand control means 23a is mounted on the engine ECU 23, the present embodiment is not restricted thereto and it may be mounted on any other hardware.

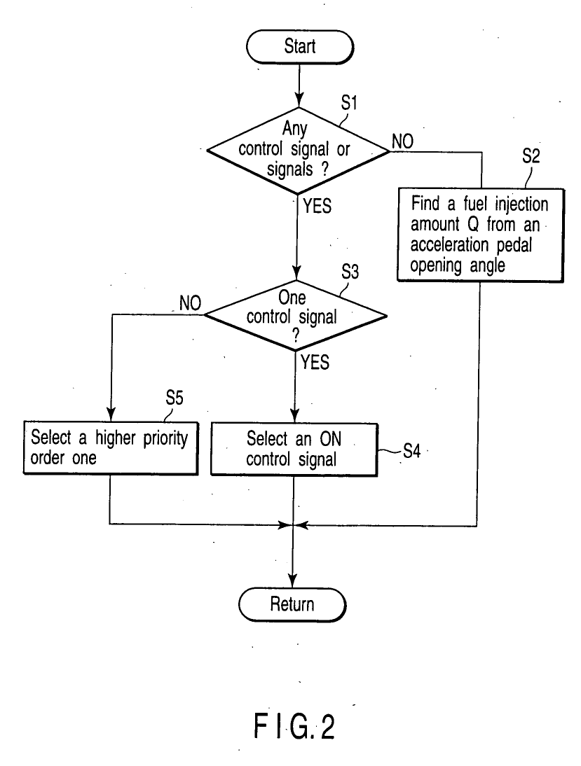

A switching control means 23b receives, as inputs, the fuel injection amounts Q1, Q2, Q3 and Q4 from the speed shift control means 21a, speed restriction control means 22a, cruise control means 22b and driver demand control means. And one fuel injection amount is selected from these according to the predetermined priority order. In the present embodiment, the fuel injection amount Q4 based on the speed shift control means 21a has the highest priority order level. Then the fuel injection amount Q3 based on the speed restriction control means 22a, fuel injection amount Q2 based on the cruise control means 22b, and fuel injection amount Q1 based on the driver demand control means 23a are sequentially lower in the priority order level. Stated in more detail, one of the liquid fuel amounts Q1, . . . , Q4 is selected according to a flowchart shown in FIG. 2 as will be set out in more detail below. Based on the selected fuel injection amount Q, the fuel injection amount of the engine 11 is controlled in a practical way.

Now an explanation will be made below about the operation of the present embodiment thus structured. First, an explanation will be made about the selection of Q1 to Q4 by the switching control means 23b. The fuel injection amount Q1 calculated by the speed restriction control means 22a, fuel control amount Q2 calculated by the cruise control means 22b, fuel injection amount Q3 calculated by the driver demand control means 23a and fuel injection amount Q4 calculated by the speed shift control means 21a are input to the switching control means 23b.

The switch control means 23b selects one of the fuel injection amounts Q1 to Q4 by the processing shown in the flowchart of FIG. 2 and outputs it to the engine 11. First, it is decided whether or not any control signal is present-Step S1. Here, the “control signal” means the fuel injection amounts Q1, Q2, Q4 calculated by the speed shift control means 21a, speed restriction control means 22a, cruise control means 22b. If the decision is made as being [NO] at step S1, the fuel injection amount Q3 input from the driver demand control means 23a is selected at step S2.

If, on the other hand, the decision is made as being [YES] at step S1, it is decided whether or not a control signal input to the switching control means 23b is one (step S3). If the decision is made as being [YES] at step S3, this one control signal (fuel injection amount) input to the switching control means 23b is selected at step S4. That is, any one of the fuel injection amount Q1, Q2, Q4 is selected.

If, on the other hand, the decision at step S3 is made as being [NO] J, a higher priority order one is selected out of these control signals input to the switching control means 23b (step S5). Here, the priority order height is set to be Q4>Q2>Q1. For example, suppose that the fuel injection amount Q4 calculated at the speed shift control means 21a is input to the switching control means 23b. Even if, in this case, the fuel injection amount Q1 calculated at the speed restriction control means 22a and the fuel injection amount Q2 calculated at the cruise control means 22b are also input to the switching control means 23b, Q4 is selected.

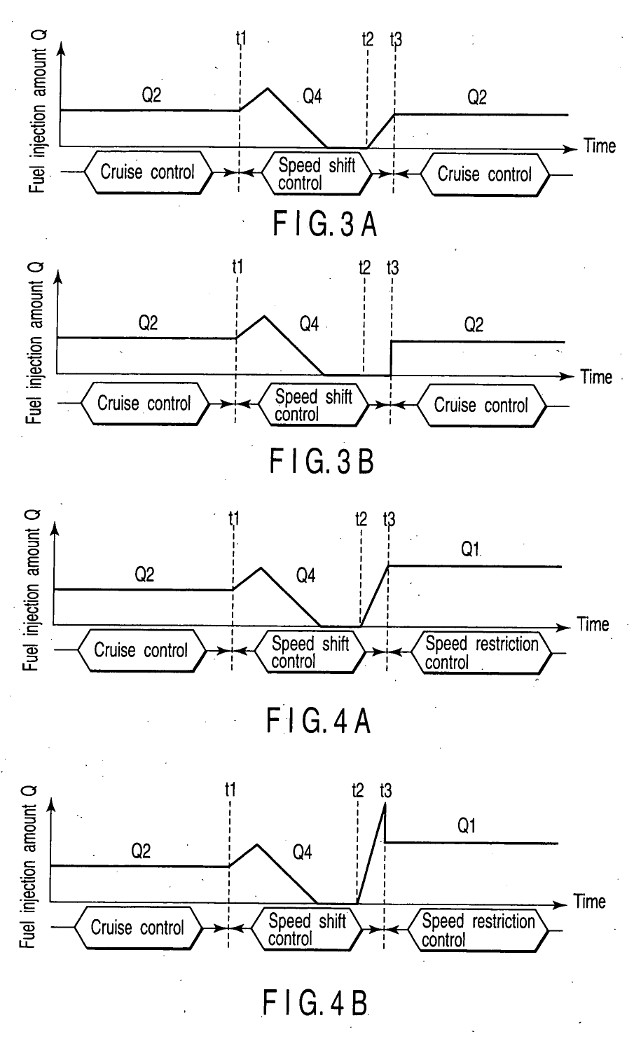

Then an explanation will be made below about an operation at a cooperation control time of the cruise control means 22b and speed shift control means 21a. Here, one practical operation is shown in FIG. 3A in which the switching control means 23b effects a switching from the cruise control means to the speed control means and, after a shift-down is effected by the speed shift control means, it is returned again back to the cruise control means.

FIG. 3A shows the coordinate in which the ordinate represents the fuel injection amount Q and the abscissa the time. The fuel injection amount Q indicated by the switching control means 23b to the engine 11 is the fuel injection amount Q2 which is output by the cruise control means 22b up to a time t1. Since a shift-down is required, at the time t1, a shifting is effected to the speed shift control. Although the shifting gears is completed at a time t2, in a time period from t1 to t2, the speed shift control means 21a calculates a fuel injection amount necessary to perform shifting gears and outputs it. When at the time t2 the speed shift is completed, the speed shift control means 21a obtains, from the switching control means 23b, information of control means (in this practical case, the cruise control means) for the next shifting. And over the time period from t2 to t3, while following the fuel injection amount to allow the fuel injection amount Q which is output to the engine 11 to be set equal to the fuel injection amount Q2 output from the shifted cruise control means, the speed shift control means effects returning control.

Upon reaching the time t3, the speed shift control means 21a ends the control and a shifting is made to the cruise control means by the switching control means 23a. By doing so, after the ending of the speed control, it is possible to effect a prompt shifting to the next control and to effectively prevent any stall.

For information, FIG. 3B shows an operation in the case of setting a fuel injection amount based on the acceleration pedal opening angle at a returning control time (t2 to t3) as in the prior art technique. During the cruise control, the driver often releases his or her foot away from the acceleration pedal and, in this case, any fuel injection amount based on the acceleration pedal opening angle is zero. As shown in FIG. 3B, therefore, at a time t2 any returning control after the end of shifting gears is not properly made and, after the shifting gears, there occurs an unwanted stall.

FIG. 4A shows a practical operation in which the switching control means is switched from the cruise control means to the stall control means and, after the shift-down is effected by the speed shift control means, a shifting is effected to the speed restriction control means.

FIG. 4A, like FIG. 3, shows the coordinate in which the ordinate represents a fuel injection amount Q and the abscissa the time. A fuel injection amount Q instructed by the switching control means 23b to the engine 11 is a fuel injection amount Q2 output from the cruise control means 22b up to a time t1. And since a shift-down is necessary a shifting is effected to the speed shift control at the time t1. The shifting gears is completed at a time t2. During a time period t1 to t2, the speed shift control means 21a calculates a fuel injection amount necessary to the shifting gears and outputs it. When at the time t2 the shifting gears is completed, the speed shift control means 21a obtains from the switching control means 23b the information of the control means for the next shifting (in this practical case, a speed restriction control means). While, over a time period t2 to t3, following the fuel injection amount to allow the fuel injection amount Q which is output to the engine 11 to be made equal to the fuel injection amount Q1 output from the shifted speed control restriction means, the speed shift control means effects returning control. Upon reaching the time t3, the speed shift control means 21a complete the control and a shifting is made to the speed restriction control means by the switching control means 23a. By doing so, it is possible to, after the completion of the shifting gears, effect a fast shifting to the next control and to effectively prevent any abrupt acceleration at the returning control time (t2 to t3).

For information, FIG. 4B shows the operation in the case of setting the fuel injection amount based on the acceleration pedal opening angle at a returning control time (t2 to t3) as in the prior art technique. During the operation of the speed restriction control, a value smaller than a fuel injection amount determined from a depressing extent of the acceleration pedal (acceleration pedal opening angle) is input to the switching control means 23b as a fuel injection amount calculated by the speed restriction control. As shown in FIG. 4B, over the time interval t2 to t3, the fuel injection amount temporarily rises as a spike and the returning control is not properly made and hence an abrupt acceleration occurs immediately after the completion of the shifting gears.

Although, as set out in detail above, in the above-mentioned embodiment, the speed shift control means, speed restriction control means, cruise control means and driver demand control means are set in a four priority order of height, even if there are any other control means other than these control means, the present invention can be applied to this case. Where, for example, any wheel spin suppression control is necessary, the priority order may be set even to this control means.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An engine output control apparatus comprising:
a cruise control section configured to control an engine output according to an acceleration/deceleration demand set according to an acceleration/deceleration demand from a driver or a cruise control demand set to match an actual vehicle speed to a preset vehicle speed or to match a vehicle distance relative to a forward-going vehicle to the preset vehicle speed, whichever demand is greater;
a speed shift control section configured to shift gears and to control the engine output according to the actual vehicle speed; and
a switching control section configured to switch the cruise control section and speed shift control section according to a priority order, wherein
the speed shift control section, upon being switched to the cruise control section by the switching control section after the completion of the shift, controls the engine output based on the next cruse control section.

2. An engine output control device according to claim 1, wherein the priority order of the speed shift control means is higher than that of the cruise control means.

3. An engine output control apparatus comprising:
a speed restriction control section configured to control an engine output according to an acceleration/deceleration demand set according to an acceleration/deceleration demand from a driver or a speed restriction demand set never to allow the actual vehicle speed to reach a predetermined vehicle speed, whichever is smaller;
a speed shift control section configured to shift gears and to control the engine speed according to the actual vehicle speed; and
a switching control section configured to switch the speed restriction control section and speed shift control section according to a priority-order, wherein
the speed shift control section, upon being switched next by the switching control section to the speed restriction control section after the completion of the shift, controls the engine output based on the speed restriction.

4. An engine output control apparatus according to claim 3, wherein the priority order of the speed shift control section is higher than that of the speed restriction control section.
